(19) United States
(12) Patent Application Publication
(10) Pub. No.: US 2025/0383475 A1
(43) Pub. Date: Dec. 18, 2025

(54) MICRO-NANO FILM LAYER

(71) Applicant: Changzhou AAC Raytech Optronics Co., Ltd., Changzhou City (CN)

(72) Inventors: Huaiyu Chen, Changzhou (CN); Jia Wang, Changzhou (CN)

(21) Appl. No.: 18/979,491

(22) Filed: Dec. 12, 2024

Related U.S. Application Data
(63) Continuation of application No. PCT/CN2024/099271, filed on Jun. 14, 2024.

(51) Int. Cl. G02B 1/11

(52) U.S. Cl. CPC G02B 1/11

(57) ABSTRACT

A micro-nano film layer includes a substrate, an intermediate layer and at least one nano film layer that are sequentially stacked, the substrate is a lens made of an APEL material, the intermediate layer is made of a silicon-aluminum mixture or silicon dioxide, and when the number of the at least one nano film layer is greater than 1, the refractive indexes of the at least one nano film layer are different from one another. Compared with the related art, the micro-nano film layer disclosed by the present disclosure has the advantages of ultra-low reflectivity, flat structure and reduced fogging effect.

### CROSS-REFERENCE TO RELATED APPLICATIONS

This application is a continuation of International Application No. PCT/CN2024/099271, filed on Jun. 14, 2024, which is hereby incorporated by reference in its entirety.

### TECHNICAL FIELD

The present disclosure relates to the technical field of lens coating, and in particular to a micro-nano film layer.

### BACKGROUND

In recent years, customers have increasingly high requirements on the quality of images captured by a camera of a mobile phone, and the lens coating technology continuously breaks through and innovates. At present, some high-end mobile phone projects have adopted a new coating technology-alumina hydrolysis process, so that ultra-low reflectivity (visible light band, reflectivity reaching 0.1%) may be obtained, a veiling glare ghost of the camera is improved, and the overall shot image quality is improved. However, the process has a problem of fogging upon real shooting due to scattering characteristics, especially after a plurality of lenses of single cameras is applied to the process, the problem is easier to be highlighted, so that scattering is too large, and shooting effect is poor.

Therefore, it is necessary to provide a new micro-nano film layer to solve the above technical problems.

### SUMMARY

An object of the present disclosure is to provide a micro-nano film layer with ultra-low reflectivity, flat structure and reduced fogging effect.

In order to achieve the object, the present disclosure provides a micro-nano film layer. The micro-nano film layer includes a substrate, an intermediate layer and at least one nano film layer that are sequentially stacked, the substrate is a lens made of an APEL material, the intermediate layer is made of a silicon-aluminum mixture or silicon dioxide, and when the number of the at least one nano film layer is greater than 1, the refractive indexes of the at least one nano film layer are different from one another.

As an improvement, one of the at least one nano film layer includes a first film layer and a second film layer that are sequentially stacked on the intermediate layer.

As an improvement, the intermediate layer has an equivalent refractive index of 1.46 and an equivalent thickness of 92 nm; the first film layer has an equivalent refractive index of 1.28 and an equivalent thickness of 104.6 nm; and the second film layer has an equivalent refractive index of 1.1 and an equivalent thickness of 120 nm.

As an improvement, a reflectivity of the at least one nano film layer satisfies that Rmax is smaller than 0.1%, and Rave is smaller than 0.1%.

Compared with the related art, in the micro-nano film layer of the present disclosure, the substrate, the intermediate layer and the at least one nano film layer are sequentially stacked; the substrate is a lens made of an APEL material, the intermediate layer is made of a silicon-aluminum mixture or silicon dioxide, and when the number of the at least one nano film layer is greater than 1, the refractive indexes of the at least one nano film layer are different from one another. Ultra-low reflectivity and low scattering may be achieved through the adjustable nano film layer, the structure of the nano composite film layer is relatively flat, and the problem of fogging upon real shooting may be solved.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic structural diagram of a micro-nano film layer according to an embodiment of the present disclosure;

FIG. 2 is a schematic diagram of simulation refractive indexes of a micro-nano film layer according to an embodiment of the present disclosure;

FIG. 3 is a curve diagram of wavelength and reflectivity of a micro-nano film layer according to an embodiment of the present disclosure; and

FIG. 4 is a schematic diagram of illumination values of scattering light when a micro-nano film layer is applied to a 6P lens according to an embodiment of the present disclosure.

| | |
|---|---|
| 100 | micro-nano film layer |
| 1 | substrate |
| 2 | intermediate layer |
| 3 | nano film layer |
| L1 | first film layer |
| L2 | second film layer |

### DESCRIPTION OF EMBODIMENTS

The technical solutions in embodiments of the present disclosure will be described clearly and completely below with reference to the drawings in the embodiments of the present disclosure. It should be clear that the described embodiments are only some rather than all of the embodiments of the present disclosure. Based on the embodiments the present disclosure, all other embodiments obtained by those skilled in the art fall within the protection scope of the present disclosure.

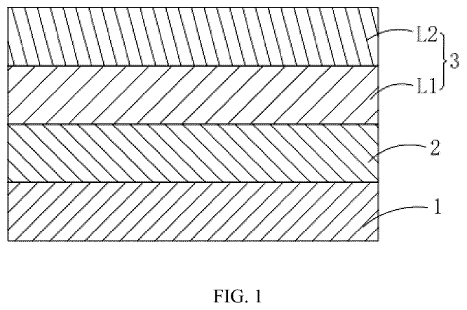

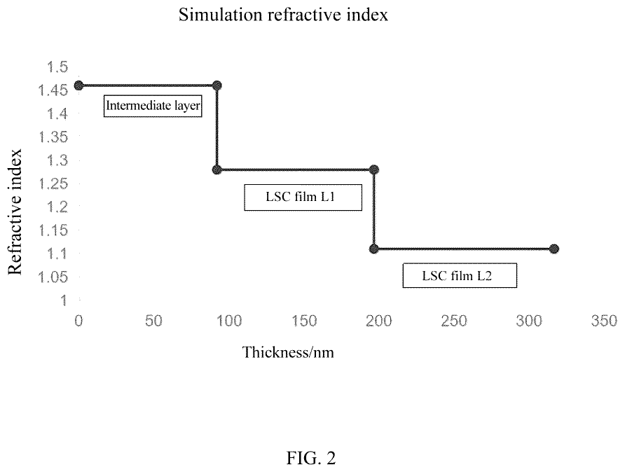

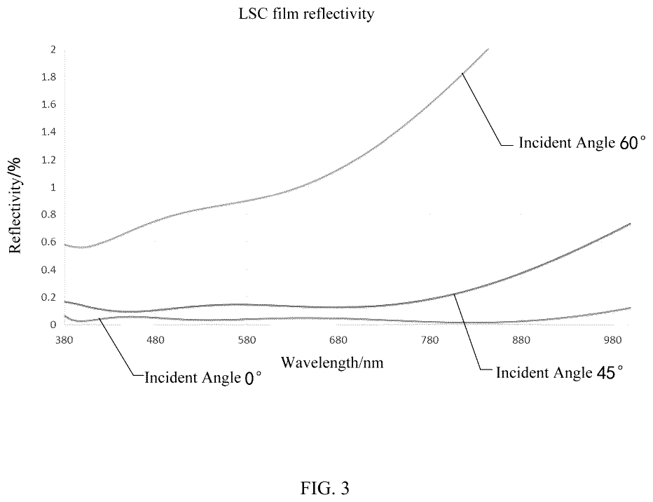

As shown in FIG. 1 to FIG. 4, an embodiment of the present disclosure provides a micro-nano film layer 100. The micro-nano film layer 100 includes a substrate 1, an intermediate layer 2 and at least one nano film layer 3 (LSC film) that are sequentially stacked, the substrate 1 is a lens made of an APEL material, the intermediate layer 2 is made of a silicon-aluminum mixture or silicon dioxide, and when the number of the at least one nano film layer is greater than 1, the refractive indexes of the at least one nano film layer 3 are different from one another. Ultra-low reflectivity and low scattering may be achieved through the adjustable nano film layer 3, the structure of the nano composite film layer is relatively flat, and the problem of fogging upon real shooting can be solved.

The APEL material is a cyclic olefin copolymer material realized by a polymerization technology.

In an embodiment, the micro-nano film layer 3 includes a first film layer L1 and a second film layer L2 that are sequentially stacked on the intermediate layer 2.

In an embodiment, the intermediate layer 2 has an equivalent refractive index of 1.46 and an equivalent thickness of 92 nm; the first film layer L1 has an equivalent refractive index of 1.28 and an equivalent thickness of 104.6 nm; and the second film layer L2 has an equivalent refractive index of 1.1 and an equivalent thickness of 120 nm.

The refractive index adjustable micro-nano film layer technology (LSC film) adjusts the refractive index by controlling the porosity of the LSC film layer, in which a small porosity of the first film layer L1 corresponds to a large refractive index, and a large porosity of the second film layer L2 corresponds to a small refractive index.

In an embodiment, a reflectivity of the nano film layer 3 satisfies that: Rmax is smaller than 0.1%, and Rave is smaller than 0.1%.

In the wavelength range of 380 nm to 900 nm, when the incident angle is 0°, a reflectivity of the nano film layer 3 satisfies that Rmax is 0.06% and Rave is 0.3%; when the incident angle is 45°, a reflectivity of the nano film layer 3 satisfies that Rmax is 0.42% and Rave is 0.17%; and when the incident angle is 60°, a reflectivity of the nano film layer 3 satisfies that Rmax is 2.39% and Rave is 1.19%.

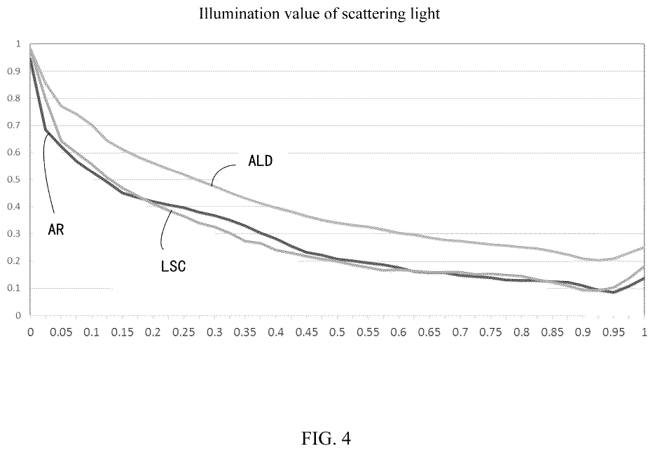

In an embodiment, when the micro-nano film layer 100 is applied to a 6P lens for comparison of real shooting effect, it is generally scattering fogging comparison and Ghost comparison. An ALD process is adopted to generate obvious fogging, and the LSC process and the conventional AR process have no obvious fogging; when the conventional AR process is adopted, the Ghost is strong; when the LSC process is adopted, the Ghost is weak; and when the ALD process is adopted, the Ghost is weak. FIG. 4 shows the illumination value of the scattering light upon shooting by the 6P lens, and the illumination value of the scattering light of the ALD process film is significantly higher than those of film layers made by AR process and LSC process. In FIG. 4, the ordinate represents the illumination value, which is closest to the light source 1, and becomes smaller when it is away from the light source; the abscissa is the relative distance from the light source, which is set to 0, and the farthest distance from the light source within the measurement range is set to 1. In an embodiment, the farthest distance from the light source is 50 centimeters, but in other embodiments, it may also be at other distances.

Compared with the related art, in the micro-nano film layer, the substrate, the intermediate layer and the at least one nano film layer are sequentially stacked; the substrate is a lens made of an APEL material, the intermediate layer is made of a silicon-aluminum mixture or silicon dioxide, and the refractive indexes of all the nano film layers are different; and ultra-low reflectivity and low scattering may be achieved through the adjustable nano film layer, the structure of the nano composite film layer is relatively flat, and the problem of fogging upon real shooting may be solved.

Those skilled in the art may understand that the above examples are specific embodiments for implementing the present disclosure, and in practical applications, various changes may be made in form and detail without departing from the spirit and scope of the present disclosure.

What is claimed is:

1. A micro-nano film layer, comprising a substrate, an intermediate layer and at least one nano film layer that are sequentially stacked, the substrate is a lens made of an APEL material, the intermediate layer is made of a silicon-aluminum mixture or silicon dioxide, and when the number of the at least one nano film layer is greater than 1, the refractive indexes of the at least one nano film layer are different from one another.

2. The micro-nano film layer as described in claim 1, wherein one of the at least one nano film layers comprise a first film layer and a second film layer that are sequentially stacked on the intermediate layer.

3. The micro-nano film layer as described in claim 2, wherein the intermediate layer has an equivalent refractive index of 1.46 and an equivalent thickness of 92 nm; the first film layer has an equivalent refractive index of 1.28 and an equivalent thickness of 104.6 nm; and the second film layer has an equivalent refractive index of 1.1 and an equivalent thickness of 120 nm.

4. The micro-nano film layer as described in claim 1, wherein a reflectivity of the at least one nano film layer satisfies that Rmax is smaller than 0.1%, and Rave is smaller than 0.1%.
